(19) United States
(12) Patent Application Publication
(10) Pub. No.: US 2003/0061179 A1
(43) Pub. Date: Mar. 27, 2003

(54) Threshold pricing in dynamically priced

(76) Inventor: Richard W. Reece, Lee, NH (US)

Correspondence Address: Richard W. Reece, 4 Captain Parker Drive, Lee, NH, 03824, US

(21) Appl. No.: 10/229,340

(22) Filed: Aug. 26, 2002

Related U.S. Application Data
(60) Provisional application No. 60/315,242, filed on Aug. 27, 2001.

(51) Int. Cl. G06F 17/60

(52) U.S. Cl. 705/412; 705/400

(57) ABSTRACT

In a telecommunications system where the price of communications is established by the network operator (“the seller”) in accordance with actual or predicted demand in such fine increments that it becomes “dynamic” from the user's perspective because the prices vary to such a high degree that individual users (“buyers”) are unable to execute a rational economic decision without incurring prohibitively high transaction costs. The present invention provides a method to reduce the transaction costs of such a system by determining and storing individual users' “threshold prices” for a variety of communications and circumstances. By comparing the network operator's offered price for the communication with the user's pre-determined threshold price, and executing a decision automatically based on the results of the comparison, the invention significantly reduces the transaction costs to the user and network operator to the point where dynamic pricing becomes viable and beneficial for both the seller and buyer.

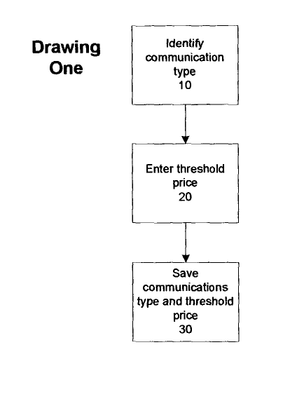

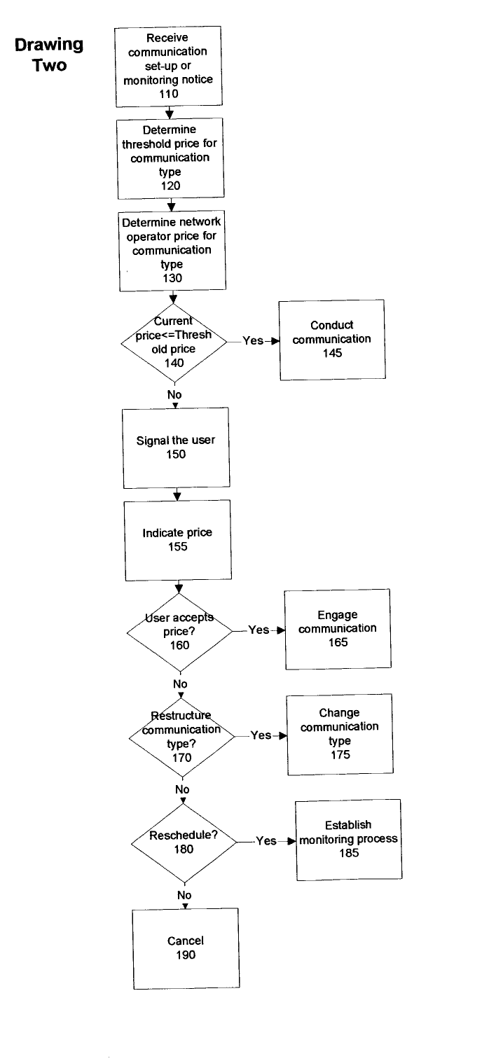

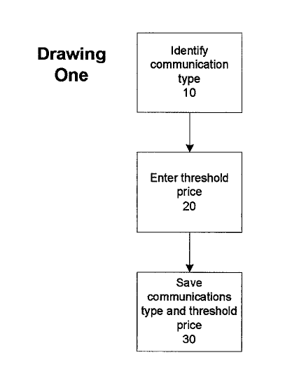

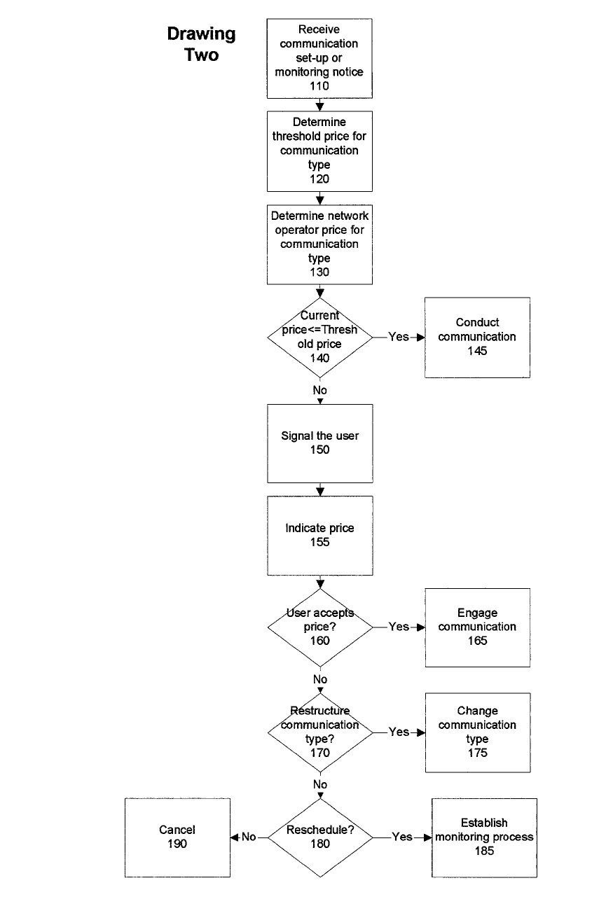

### CROSS REFERENCE TO RELATED APPLICATIONS

This application claims priority under 35 USC .sctn. 199(e)(1) of provisional application No. 60/315,242 filed Aug. 27, 2001.

### BACKGROUND OF THE PRESENT INVENTION

The present invention operates in a telecommunications system where the network operator (the service provider) utilizes dynamic (or “congestion”) pricing as the means of pricing (or “rating”) the communications services it provides to users (“consumers”). In general terms, dynamic pricing is a process where the network operator adjusts its prices so that demand (which is variable) is brought into equilibrium with supply (which is fixed in the short-term). For example, the operator may elect to reduce prices at different times and locations to stimulate demand for under-utilized networks assets. At other times, the network operator may raise prices in order to reduce demand to limit traffic to the available capacity.

There are considerable advantages to a dynamic pricing system. One is that dynamic pricing provides the foundation for a yield management system, where the network operator optimizes prices so that the resulting demand and revenue will meet the operator's targets for network utilization, revenue, and quality of service. The yield management process also has the desirable effect of inducing consumers with low priority communications to shift their demand to “off-peak” times and locations, thus allowing the same fixed quantity of capacity to handle a greater volume of demand over a period of time (such as a twenty-four period). From an economic standpoint, such a process is more economically efficient than the standard practice of over-building networks to accommodate the “peak busy hour” demand, which by definition creates excess capacity in the other twenty-three hours of the day. Yield management systems are commonly found in industries with high fixed costs and constantly expiring inventory, such as airlines, hotels, and car rental companies. However, dynamic pricing in the telecommunications industry is extremely rudimentary by comparison: most network operators do not offer subscriptions that change prices more than twice a day (“peak” and “off-peak”), and even these are becoming rare despite the technical economic advantages of such plans.

There are two significant impediments to dynamic pricing in telecommunications. The first impediment is that the prices must be delivered to the consumer at the time of sale (the provision of the communication). This may be resolved in several ways—for example, through the use of stored subscription data, a query to a database, or a one way broadcast of prices to the device. The prices may then be displayed to the user before the communication is conducted, thus allowing the consumer to make a conscious economic decision on the relative value of the communication. But the requirement for a constant series of economic decisions involving very small transactions creates the second impediment: “mental transaction costs” (the mental effort and time required to make a decision) that are too high for the dynamic pricing system to work effectively. In other words, consumers will find it too troublesome to make a rational economic decision on every single communication because the price of the transaction is simply too small to be worth the time and effort. If consumers are unwilling to execute these decisions, the dynamic pricing system simply will not function because the consumers will not participate.

### SUMMARY OF THE PRESENT INVENTION

It is therefore an objective of the present invention to provide a system and method by which consumers of telecommunications services will be able to make a rational economic decision in a dynamic pricing environment without imposing high ?mental transaction costs”. It is a further objective of the present invention to increase the precision and applicability of a dynamic pricing process, and the overall utility of such process for the network operator and consumer. Another objective of the present invention is that the method will be capable of rapid execution in order to further minimize the economic transactions costs (e.g. time and processing power).

In summary, the present invention utilizes user-defined “threshold prices” to reduce the transaction costs and burden placed on a user's decision making process in a dynamically priced telecommunications network. These thresholds are pre-determined and stored in a telecommunication device's memory. Users will attach threshold prices to different communications types, which may be defined by a wide range of attributes. For example, a threshold price might be attached to all emails, or emails to a specific individual, or emails to a specific individual undertaken at certain times of the day. The threshold price represents the highest price the user is willing to pay for conducting the communications type that the user has elected to predefine. By setting a list of attributes or constraints on each communication type, the user may define a wide number of communications types and may specify a threshold price for each communications type.

When a user elects to conduct a communications through an operator's network, the threshold pricing process of the present invention determines the communications type and determines the threshold price that the user has established for this type. The threshold pricing process next determines the network operator's current price for conducting this communication type, either by querying the operator, a broadcast update from the operator, or a set of prices stored in a user's device's memory. The threshold pricing process compares the threshold price with the network operator's price. If the network operator's price is less than or equal to the threshold price, the threshold pricing process will allow the communication to continue or start the set-up process. If the network operator's price exceeds the threshold price, the process will generate several options for the user. The threshold pricing process may signal the user, indicate the current price of the communications, and, if the user actively elects to accept this price, the process will allow the communications to continue. Other options include enabling the user to reschedule the communication for a time when the price threshold is met, or restructure the communication type, or cancel the communication.

The same basic threshold pricing process may be undertaken before the communication is set-up and during an ongoing communication (where the threshold pricing process monitors for price changes that exceed the threshold price).

It is an advantage of the current invention that the “mental transaction costs” are significantly reduced by determining and storing a user's general price preferences so that these preferences may be applied automatically to many individual transactions. In this manner, the user effectively achieves “economies of scale” in his or her decision-making process: one decision may be applied to many separate transactions. The advantage of this method over the current art is that the parameters and defining attributes may be segmented in finer detail than with a standard monthly subscription that is common in the current art. A further advantage of this invention is that the economic decision will accurately reflect the consumer's reservation price and preferences without imposing any additional mental transaction costs upon the consumer at the time of the communication. Yet another advantage is that the system and method still provides the flexibility to enable the user to execute a conscious economic decision to override the pre-defined threshold in certain circumstances.

It is a substantial advantage that the present invention will reduce the price discovery and monitoring costs for the end user to a point where the user will accept the cost of participating in a dynamic pricing process for all communications. This capability will enable the extension of a dynamic pricing process to cover virtually all of the user originated communications, thus allowing both the network operator and user to obtain the mutual benefits of dynamic pricing.

### BRIEF DESCRIPTION OF THE DRAWINGS

Drawing One—A block diagram indicating the process flow for entering a communication type and threshold price.

Drawing Two—A block diagram indicating the process flow for using threshold prices in a dynamic pricing environment.

### DETAILED DESCRIPTION OF THE PRESENT INVENTION

The “user device” in the following description may be any device a user utilizes to engage in communications or data transfer through a telecommunications network engaged in the process of dynamic pricing. Such a device may be a wireless handset, a personal computer, a specially adapted wired telephone, personal digital assistant, or any other device designed to communicate information through a telecommunications network. In a preferred embodiment, the device will have a display screen to facilitate threshold pricing entry, communication type attribute identification, and the display of prices in the event that the threshold price has been exceeded. However, the use of voice recognition technology and voice recordings may substitute for the visual display in the present invention, though using this means of data presentation and entry may be cumbersome in some environments.

In some instances, the user device will be a separate communication device operated by the user's “agent”, a software program that retains in local memory the user's preferences and establishes communications for the user according to these predefined parameters. This device may not resemble a traditional communications device, but if it is undertaking a communication through a dynamically priced operator's network, the device would benefit from the present invention.

Establish Threshold Prices

The user must first establish a set of “threshold prices” for anticipated communications. Communications from a specific communications device may be defined by the user according to a set of attributes (10). For the purposes of discussing the present invention, each attribute, either separately or as part of a set of attributes, defines a communication “type”, and each communication type may be assigned a threshold price.

Attributes may span the technical capabilities of the communications device and the communications network. For example, in a wireless communications device, wireless communications may take the form of a voice call, a circuit switched data connection, a packet switched two-way connection, a one way packet message, or possibly other forms as well. Wireline communications systems operating through a “wired” device may communicate via the PSTN, a coaxial cable connection, a fiber optic line, or even the electrical lines. In addition, each of these forms of communication might have different operating parameters and data rates, which the use may elect to use as attributes that define the communications type.

The communications type may also be defined by attributes related to the information format or content of a specific communication. For example, a user may elect to use attributes indicating an email, news broadcasts, voice communications, videoconferencing, instant messaging, and so on. For the end-user, each of these communications types will also have a separate value, and different thresholds may be set depending on the form of the communication as well. The user may elect to be even more specific, such as indicating, a specific email address or a particular phone number.

In the context of the present invention, attributes may also include conditional parameters, such as the user's current location or the time of day.

For each communication type defined by the user's set of attributes, the user will assign a threshold price (20). This threshold price represents the user's reservation price, the maximum price the user is willing to pay for the specific communication type (as defined by the set of attributes). This communication type, its defining attributes, and its threshold price will, in the preferred embodiment, be stored in local, non-volatile memory on the user's communication device or in some other form of non-volatile data storage that may be connected to the communications device by the user (such as a memory card).

In some instances, it may be advantageous for the user to pass the threshold prices and communications types to a third party agent, or, in some instances, the network itself. A third party agent might be a “download manager” that provides information pushes on a scheduled basis, such as news or traffic updates. In some embodiments, it will be more efficient for the user, agent, and network operator if the thresholds and communications types for individual users reside in the download agent or push server.

The communication type (with its complete set of identifying attributes) will be saved in the device's memory (or the device used by the user's agent) with the relevant threshold price (30). Preferably, this communication type and threshold price should be stored in long-term non-volatile memory.

Operational Overview

The user or the user's agent (a software program acting according to the instructions and parameters indicated by the user, or some other entity representing the billing interests of the user) indicates to the threshold pricing control process that a specific communications type on a specific network is to be conducted (110). This may take the form of dialing a number, or pressing the send button on a wireless handset, or indicating that an email should be sent or some other triggering process that would normally signal the communications process to commence. The key aspect is that the user has determined that a communication is to be sent, and that the information content, or at least key aspects of the information content, have been determined by the user and assigned a value.

(It is unlikely that the user has actually assigned a specific price to the communication, but by undertaking the act of starting a communication, the user has indicated, implicitly, that the communication has value. One advantage of the threshold pricing system of the current invention is that the use of thresholds at the appropriate time will help the user minimize the amount of effort and precision required to determine the value of a specific communication.)

If a user has elected to use an agent to conduct scheduled communications (such as automatic email downloads, or news updates) the threshold pricing process may not occur within the user's device, or within a device under the user's immediate control. In these situations, the user has defined a set of operating parameters for the agent, and the agent acts for the user within these parameters. The threshold pricing process may applied by either the user or the user's agent acting in the user's interest. For example, an email server might be equipped with the capability to access a network operator's dynamic pricing information and the threshold pricing process, thus allowing it to determine according to the user's predefined thresholds, whether or not the user's emails should be pushed to the user's device.

In a preferred embodiment, the threshold pricing process is engaged before the communication is established, and may be activated during an ongoing communication to monitor for changes in the price of the communications network being used.

The threshold price process evaluates the type of the communication by examining the defining attributes. It seeks a matching communication type in the memory to determine if the user has defined a threshold price (120). The threshold pricing process retrieves the threshold price assigned to the communication type. This threshold price may be held in a buffer, or otherwise referenced so that it may be readily compared to the current price of the asset.

The threshold price process determines the current price of the communications network for conducting the specific communication type requested by the user (130). If the network operator's pricing system provides multiple communications types, the device or the user must identify the correct price that the network operator will apply to the communications type requested by the user.

In general, the pricing system of the network operator will have a more limited set of differentiating attributes, and these attributes will likely be focused on the technical capabilities and parameters of the network's communications capabilities. For example, the network operator might assign different prices to different data rates per second, or different packet loss probabilities, and so on. But it is unlikely that the network operator will assign specific thresholds to the full range of attributes that the user might assign in addition to the technical parameters, such as the called party number.

In other words, the communications type defined by the user is likely to be a subset of the communications types defined by the network operator. For instance, the network operator may assign a price simply to a standard voice call based on a per minute rate for an interval of time, while the user might have assigned a specific threshold price to a voice call undertaken for a time interval for a specific number. (e.g. Between the hours of 7 am and 10 am, when calling a work related number, the threshold price is $x.xx).

As those skilled in the art will appreciate, there arena number of possible methods for acquiring the price of the communications type from the network. The present invention is not specific to the actual method used by the device to obtain the dynamic price. In general, there are three broad methods. One is query-response, where the device queries a central database that contains the current prices charged by the network operator for the specific communications services required. The second method uses a broadcast or “push” operation, where the prices of the communications assets are transmitted to the device and stored by the device in memory for use at the necessary time. The threshold pricing process of the current invention will benefit both methods. The third method is to predict the “dynamic” prices based on past data, operating history, and other parameters and to store these prices in memory that may be accessed by the user's device. This memory may be local (on the user's device) or stored in a central location that may be queried by the user's device. In this latter instance, the prices are dynamic in the sense that they are changing often and rapidly, though in response to predicted demand rather than actual demand.

The threshold pricing process compares the user's threshold price to the applicable price charged by the operator's network (140). As those skilled in the art will appreciate, it may be possible for the threshold price process to perform additional calculations to provide a more accurate prediction of the probable charges for the communication.

If the network operator's current price for the communications type requested by the user is less than or equal to the threshold price defined by the user, the threshold price process will allow the communication to commence or continue without further user intervention (145). In some instances, the user may want the current price to be displayed even when it falls under the threshold level, but this is not necessary for the operation of the present invention. If the price of the communication is within the threshold set by the user, the method of the present invention will allow the device to continue and communicate “automatically”—that is, without requiring further user intervention in the price discovery and confirmation process. This is a significant advantage of the present invention: when the price of the communications meets threshold, the user is not required to engage in or acknowledge an active price decision. The method of this invention is advantageous in comparison to software pricing agents that attempt to “negotiate” a mutually agreeable price with the supplier because it is a “take it or leave” process that enables rapid decision-making with very little processing power. “Negotiations” entail greater complexity and information exchange between the two parties, thus creating delays and additional mechanisms designed to reconcile conflicts and common terms between the two parties. In the present invention, the information that must be delivered to the user's “agent” is minimal (the current price and defining attributes), flows in one direction, and requires no response from the user to accept or deny the transaction. If the threshold is not exceeded, the communication process continues creating an implicit acknowledgement and completion of the contract.

This process minimizes the burdens and transaction costs imposed on the user without surrendering the valuable economic effects of dynamic prices. As those skilled in the art will note, the dynamic prices will continue to operate; by using the threshold price, the user has signaled a willingness to accept all prices under the threshold.

It is only when the current price exceeds the threshold that the user may be required to intervene and make an active valuation decision. If the current price of the communication exceeds the threshold price, the device must signal the user (150) and obtain confirmation that the user accepts the current price for the communications type before the communication can proceed. This signaling process may take on many different forms, such as a visual display, an audio tone, or a vibration in the device. The signal is used to draw the user's attention to the current price of the communications type, which will be indicated to the user on the device's display (if available) or the current price may be provided via an automatic voice message if a display is not available (155). The original threshold price may also be displayed or otherwise indicated, but this is not required.

In embodiments where the user or consumer is unavailable for manual decision-making (as with embedded devices), exceeding the threshold may result in a simple decision to continue with the communication. No further action or signal to the user or the network is required as the communication will not be initiated. This is a further advantage of the method of the invention: the transaction cost of determining not to communicate is extremely small and the cost is borne by the user (or the user's device) rather than placed ion or shared with the network operator (as with a “negotiating” software agent).

In embodiments where users are available to respond to manually to a condition where the current price has exceeded the threshold price, the user will have at least two options. In a very basic implementation, the user may either accept the higher price and continue the communication, or reject the price and cancel the communication. In more sophisticated embodiments, those skilled in the art will appreciate that additional options may be added to help conduct the desired communication at a price that is acceptable for both the user and the network operator. For example, this might involve restructuring the communications type or rescheduling the communications for a time when the price meets the threshold price constraints.

When the user elects to continue the communication, thereby accepting the higher price and the implicit contract, the user indicates this acceptance through some means of positive feedback, such as manually depressing a key, issuing a voice command, and so on (160). The communication will then be conducted as normal (165). It is important that the threshold pricing process requires an active response from the user to indicate acceptance of the current price. (A passive acceptance is, of course, technically feasible, but would not have the same level of validity and certainty provided by an active response. If some positive feedback from the user is not obtained, it will not be certain whether the user is accepting the price or simply is unable to respond to the signal. Ambiguity could have a negative impact on the user and in the long term on the network provider's dynamic pricing process as well.)

The user may cancel the communication also through an active response (pushing a button) or through passive inactivity. If no action is take, the current process described in this current invention assumes that user did not accept the price, and the communication will not be conducted.

The threshold pricing process may also allow a user to restructure the communications type to find a price that will meet the user's predefined threshold (170 and 175). For example, the user may allow an email transmission to accept a lower quality of service standard in order to find a threshold price that is below the price offered by the network operator for that service.

The threshold pricing process may also allow the user to reschedule the communications for a time when the network operator's prices meet the user's threshold price (180 and 185). Those skilled in the art will appreciate that there are many possible options. One option will allow the user to instruct the threshold pricing process to monitor (or query on a predetermined interval) the network operator's prices. When the price for the target communication falls below the threshold price, the download may start automatically (or with user confirmation). In some embodiments, the user may also elect to indicate a new price threshold for this specific communication, and may also indicate an upper time limit for attempting this automatic communication.

In some situations, the threshold pricing process will be engaged to monitor an ongoing communication. For some types of communication, it will be possible—and preferable—for the communication to be automatically placed on hold or “paused” when prices rise above the threshold price, and resumed when prices fall back below the threshold. For example, while downloading a large file through a relatively small bandwidth channel, the price of the communications type might rise in response to other traffic on the network. The threshold pricing process could pause the download automatically, and then resume the download when traffic subsides and prices fall again.

The threshold pricing process will also allow a user to cancel a communication completely (190).

The advantage of the threshold pricing process of the present invention is that it allows users to undertake communications in a dynamic pricing telecommunications environment in a manner that preserves the key elements of dynamic pricing without imposing high transaction or use costs upon the user. The user is only required to make a conscious decision on the value of the specific communication if the threshold price is exceeded. Users who are price sensitive will set low thresholds, and will need to make more frequent decisions on the value of their communications; users who are not will set higher thresholds and will make infrequent decisions on the value of a specific communication. Both circumstances will help the individual user, and the network operator.

What is claimed is:

1. A method for executing an economic decision to communicate through a telecommunications system that is comprised of the following steps:
determining a user's reservation (or “threshold”) price for communications of varying attributes
recording the user's threshold price and the identifying attributes in computer memory
determining a user's election to execute a communication
determining the type and attributes of the communication
matching the type and attributes to a unique pre-determined threshold price
matching the type and attributes of the communication to a price provided by the network operator for a communication of matching type and attributes
determining if the current price for the communication provided by the network operator exceeds the threshold price (the user's reservation price) for the communication.

2. The method of claim 1 where the prices are provided by the network operator as a pre-defined set of prices that are stored in local non-volatile memory in the user's device.

3. The method of claim 1 where the prices provided by the network operator are broadcast to the user's device and stored in short-term (volatile) memory.

4. The method of claim 1 where the prices provided by the network operator are stored in a non-volatile memory storage device that is not in the user's device and is available by query through the network operator's communications network
